(19) United States
(12) Patent Application Publication
(10) Pub. No.: US 2008/0018788 A1
(43) Pub. Date: Jan. 24, 2008

(54) Methods and systems of deinterlacing using super resolution technology

(75) Inventors: Zhi Zhou, Corona, CA (US); Yeong-Taeg Kim, Irvine, CA (US); Mahesh Chappalli, Irvine, CA (US); Surapong Lertrattanapanich, Irvine, CA (US)

Correspondence Address: Kenneth L. Sherman, Esq.;Myers Dawes Andras & Sherman, LLP, 19900 MacArthur Blvd., 11th Floor, Irvine, CA, 92612, US

(73) Assignee: Samsung Electronics Co., Ltd., Suwon City (KR)

(21) Appl. No.: 11/490,934

(22) Filed: Jul. 20, 2006

(51) Int. Cl. H04N 11/20; H04N 7/01

(52) U.S. Cl. 348/452; 348/448

(57) ABSTRACT

A method of super resolution-based deintelacing processing in interlaced video sequences is provided. Block matching is applied on each image block to obtain a motion vector MV. Using MV as the initial motion vector, optical flow is applied on that block to obtain a sub-pixel resolution motion vector OF. Missing pixels are then interpolated using motion vector OF and one or more images in the sequence.

### FIELD OF THE INVENTION

The present invention relates generally to image processing, and in particular to deinterlacing processing in interlaced video sequences.

### BACKGROUND OF THE INVENTION

In the development of Digital TV (DTV) systems, it is essential to employ video format conversion units because of the variety of the video formats adopted in many different DTV standards worldwide. For example, the ATSC DTV standard system of North America adopted 1080×1920 interlaced video, 720×1280 progressive video, 720×480 interlaced and progressive video, etc. as its standard video formats for digital TV broadcasting.

A video format conversion operation is to convert an incoming video format to a specified output video format, in order to properly present the video signal on a display device (e.g., monitor, FLCD, Plasma display) which has a fixed resolution. A proper video format conversion system is important as it can directly affect the visual quality of the video of a DTV Receiver. Fundamentally, a video format conversion operation requires advanced algorithms for multi-rate system design, poly-phase filter design, and interlaced-to-progressive scanning rate conversion or simply deinterlacing, where deinterlacing represents an operation that doubles the vertical scanning rate of the interlaced video signal.

Historically, deinterlacing algorithms were developed to enhance the video quality of NTSC TV receivers by reducing the intrinsic annoying artifacts of the interlaced video signal such as a serrate line observed when there is motion between fields, line flickering, raster line visibility, and field flickering. These also apply to a DTV Receiver.

Elaborate deinterlacing algorithms utilizing motion compensation allows doubling the vertical scanning rate of the interlaced video signal especially for motion objects in the video signal. Motion compensated deinterlacing operation can be used for analog and digital TV receivers.

Most of the motion compensated deinterlacing algorithms found in the literature have limitations. Such methods often use the block-matching methods to search the motion vector of pixel or half-pixel resolution. The motion compensated pixel may not be correct when the true motion has more resolution.

### BRIEF SUMMARY OF THE INVENTION

A method of super resolution-based deinterlacing processing in interlaced video sequences is provided. Block matching is applied on each image block to obtain a motion vector MV. Using MV as the initial motion vector, optical flow is applied on that block to obtain a sub-pixel resolution motion vector OF. Missing pixels are then interpolated using motion vector OF and one or more images in the sequence.

The present invention further provides systems to implement the above methods. Generally, block-based motion estimation can only search the motion vector with pixel or half-pixel resolution. While the super resolution technology optical flow can obtain the motion vector with sub-pixel resolution. More accurate motion vectors lead to better deinterlacing results.

These and other features, aspects and advantages of the present invention will become understood with reference to the following description, appended claims and accompanying figures.

### BRIEF DESCRIPTION OF THE DRAWINGS

FIG. 1 shows a pictorial example of the top and bottom fields of an interlaced video sequence.

FIG. 2 shows a pictorial example of blocks in an interlaced image.

FIG. 3 shows a diagrammatical example of a super resolution based deinterlacing method, according to an embodiment of the present invention.

FIG. 4 shows an example block diagram of a super resolution based deinterlacing system, according to an embodiment of the present invention.

FIG. 5 shows a diagrammatical example of symmetric motion estimation for an interlaced video sequence, according to an embodiment of the present invention.

FIGS. 6A-B shows examples of symmetric block matching in an interlaced video sequence, according to an embodiment of the present invention.

FIG. 7 shows an example block diagram of a super resolution based deinterlacing system, according to an embodiment of the present invention.

FIG. 8 shows an example block diagram of a super resolution based deinterlacing system, according to an embodiment of the present invention.

### DETAILED DESCRIPTION OF THE INVENTION

In one embodiment, the present invention provides a super resolution based deinterlacing method and apparatus for processing an interlaced video sequence. Such a super resolution-based deinterlacing method includes the steps of, for each block of pixels in a video frame: Applying block matching on that block to obtain a motion vector (MV); Using the MV as the initial motion vector and applying optical flow on that block to obtain a sub-pixel resolution motion vector; and interpolating missing pixels in that block using motion compensation.

In order to systematically describe the deinterlacing problem and a deinterlacing method according to the present invention, in the following description let fₜ denote an incoming interlaced video field at time instant t, and fₜ(v,h) denote the associated value of the video signal at the geometrical location (v,h) where v represents vertical location and h represents horizontal location. In this description, field comprises interlaced video information, frame comprises progressive video information, image represents one frame or field, and block comprises a small area in the field/frame/image.

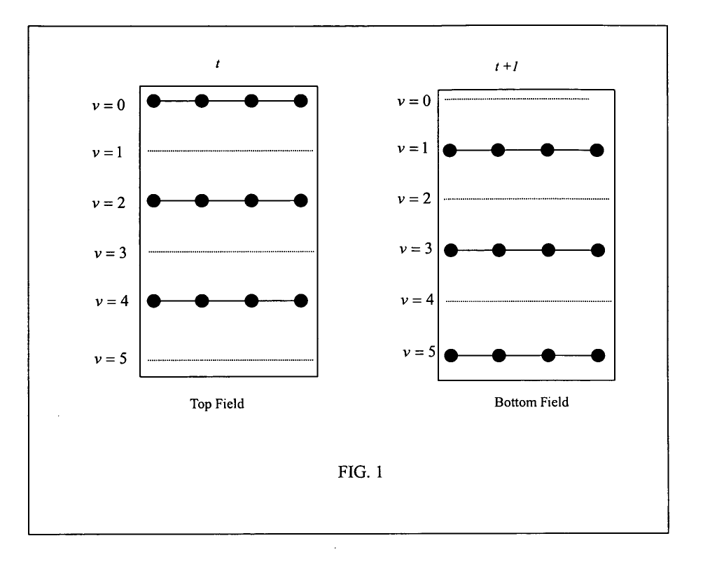

FIG. 1 shows a pictorial example of top and bottom fields of an interlaced video sequence. Referring to the example in FIG. 1, an image at time t represents a top field and an image at t+1 represents a bottom field of an interlaced video sequence. By the definition of a interlaced video signal, the signal values of fₜ are available (solid circles) only for the even lines, i.e., v=0, 2, 4, . . . , if fₜ is the top field. Similarly, the signal values of fₜ are available (solid circles) only for the odd lines of v (i.e., v=1, 3, 5, . . . ) if fₜ is the bottom field. Conversely, the signal values of fₜ are not available for odd lines if fₜ is a top field signal and the signal values of fₜ are not available for even lines if fₜ is a bottom field. Top and bottom fields are typically available in turn, in time.

Based upon the above description of the interlaced video signal, a deinterlacing problem can be stated as a process to reconstruct or interpolate the unavailable signal values in each field. That is, the deinterlacing problem is to reconstruct the signal values of fₜ at odd lines (v=1, 3, 5, . . . ) for top field fₜ and to reconstruct the signal values of fₜ at even lines (v=0, 2, 4, . . . ) for bottom field fₜ.

For clarity of description herein and without limitation, the deinterlacing problem is simplified as a process which spatially reconstructs or interpolates the unavailable signal value of fₜ at the i^{th} line where the signal values of the lines at i±1, i±3, i±5, . . . are available. More simply, deinterlacing is to interpolate the value of fₜ(i,h), which is not originally available.

Generally, super resolution technologies are used in image scaling to interpolate a pixel with motion compensation. Optical flow, one of the super resolution motion estimation methods, is a well-known method to estimate the global motion of the whole image. However, due to hardware limitations, optical flow cannot be applied on the whole image in practical hardware implementation.

According to an embodiment of the present invention, optical flow is combined with a block matching motion estimation method, to search the sub-pixel resolution motion vector of each block of pixels in an interlaced image.

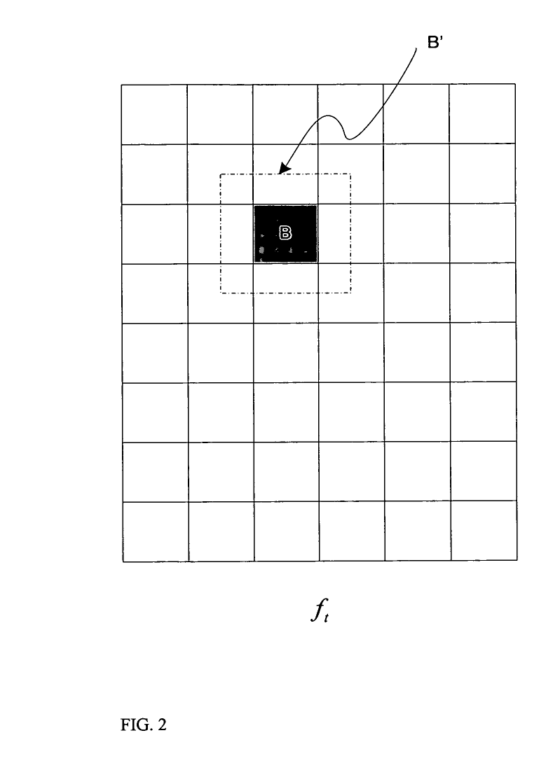

FIG. 2 shows a pictorial example of blocks in an interlaced image. For clarity of description herein and without limitation, in FIG. 2 the interlaced image fₜ is divided into multiple blocks B. A deinterlacing method according to the present invention is applied on each block of image fₜ from left to right, from top to bottom. The deinterlacing method estimates the motion vector of each block and then interpolates the missing pixels in that block based on the motion vector.

To improve the robustness of the motion estimation, the motion estimation can be applied on overlapped blocks. For example, as shown in FIG. 2, block B is the block to be processed and B′ is the larger external block of block B. The motion estimation is applied on block B′ to search the motion vector (i.e., the displacement between the block B and the matching block in previous field), and interpolate the missing pixels in block B. Searching the motion vector comprises a process to find the matching block and compute the displacement.

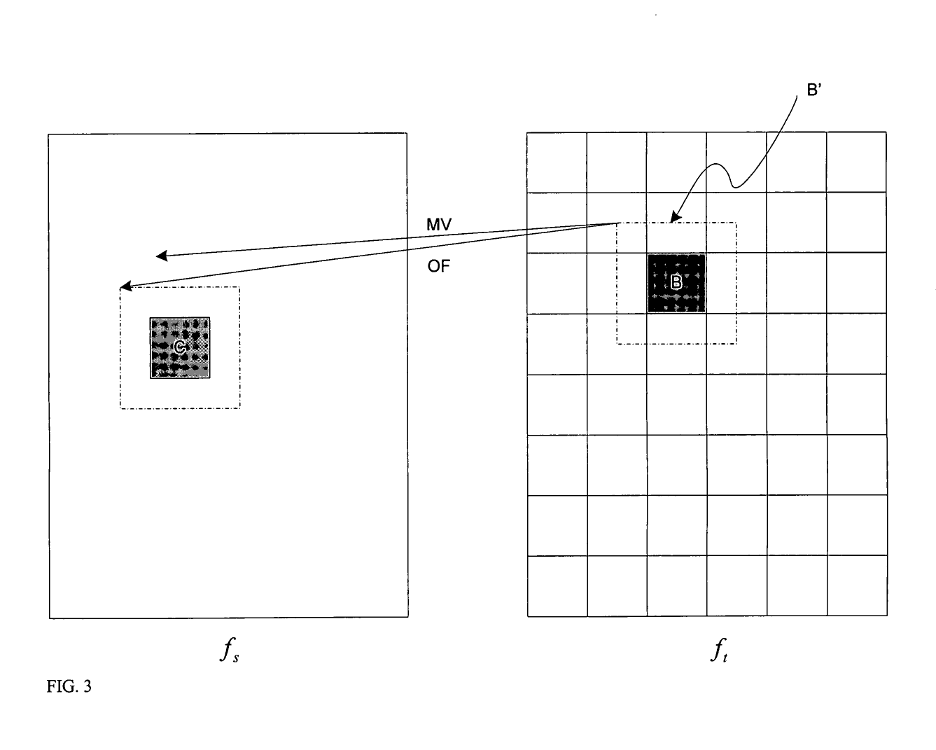

FIG. 3 shows a diagrammatical example of a super resolution based deinterlacing method, according to an embodiment of the present invention. To interpolate the missing pixels in an arbitrary block B in the current field fₜ, a block matching based motion estimation is first applied on the external block B′ between the current field fₜ and one of its neighboring field (temporally), denoted as fₛ, to obtain a motion vector MV representing displacement between the external block B′ and its matching block in fₛ,]. There is no limitation on which block matching method is used. The simplest example can be full search, and other methods include three step search, diamond search, etc. Other examples are possible.

The motion vector MV is then used as the initial motion vector of optical flow applied to the external block B′. The optical flow refines the motion vector MV into sub-pixel resolution (i.e., motion vector having fractional part of pixel resolution), to obtain a sub-pixel resolution motion vector OF representing the sub-pixel resolution motion vector. There is no limitation on which motion model is used in optical flow One example can be a rigid model. Other examples are possible.

Based on the obtained sub-pixel resolution motion vector OF, a matched block C in image fₛ can be interpolated. The matched block C is most similar to block B in a neighborhood field in image fₛ. Interpolating block C involves interpolating each pixel in block C based on the spatial pixels, since block C may not be aligned with pixels in fₛ, and the pixels in block C are not originally available.

There is no limitation on which method is used in interpolation of block C. It can be bilinear, bi-cubic or poly-phase filter. Other examples are possible.

Thus, the missing pixels in block B are obtained from block C with motion compensation. Interpolation of block C reconstructs a missing pixel in block B of frame fₜ as follows. All of the pixels in block C are interpolated spatially. Each missing pixel in block B should have one matched pixel in block C. The matched pixel is copied from block C to block B to obtain the missing pixel.

The missing pixels in block B are obtained from block C with motion compensation as blocks B and C have motion (displacement) between them. After processing all the blocks of image fₜ, a deinterlaced image is obtained.

In the examples, both block matching and optical flow are applied on the same images. According to the present invention, this can be further extended to different images. In one example, block matching is applied between the current image fₜ and the neighboring (temporally) image fₛ. Optical flow is applied between the current image fₜ and another neighboring (temporally) image fᵣ. The initial motion vector of optical flow can be obtained based on the block matching result and displacement of the three images fₜ, fₛ, fᵣ in time axis.

In the following, example deinterlacing systems implementing super resolution based deinterlacing methods, according to the present invention, are described.

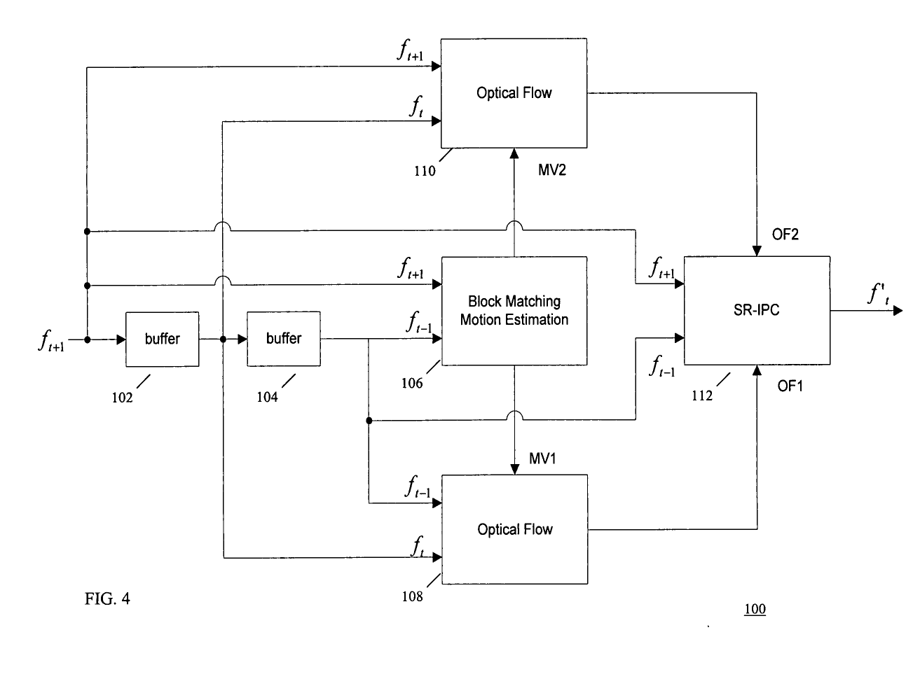

FIG. 4 shows an example block diagram of a super resolution based deinterlacing system 100, according to an embodiment of the present invention. The system 100 includes buffers 102, 104, block matching motion estimation unit (BMME) 106, optical flow units 108, 110 and SE-SIPC 112. Buffers 102, 104 maintain the previous and previous-previous fields, respectively.

In system 100, assume input image fₜ is the current image, block B is the current block to be processed, and block B′ is the external block of B. The BMME unit 106 first searches the symmetric motion vector of block B between the previous image fₜ₋₁ and the next image fₜ₊₁, and generates motion vectors MV1 and MV2. MV1 is the motion vector from the current image fₜ to the previous image fₜ₋₁, and MV2 is the motion vector from the current image fₜ to the next image fₜ₊₁.

Based on the initial motion vector MV1, optical flow unit 108 is applied on block B′ between the current image fₜ and the previous image fₜ₋₁, to generate a sub-pixel resolution motion vector OF1. Based on the initial motion vector MV2, optical flow unit 110 is applied on block B′ between the current image fₜ and the next image fₜ₊₁, to a sub-pixel resolution motion vector OF2.

Thus, each missing pixel in block B has two motion compensated pixels: one is interpolated in the previous image fₜ₋₁ and the other is interpolated in the next image fₜ₊₁. Each missing pixel can be interpolated by taking the average of those two motion compensated pixels. There is no limitation on method of interpolate the missing pixel. SR-IPC 112 in FIG. 4 interpolates the missing pixel based on the sub-pixel resolution pixels. f′ₜ is after SR-IPC 112 interpolation, whereby f′ₜ comprises a de-interlaced frame.

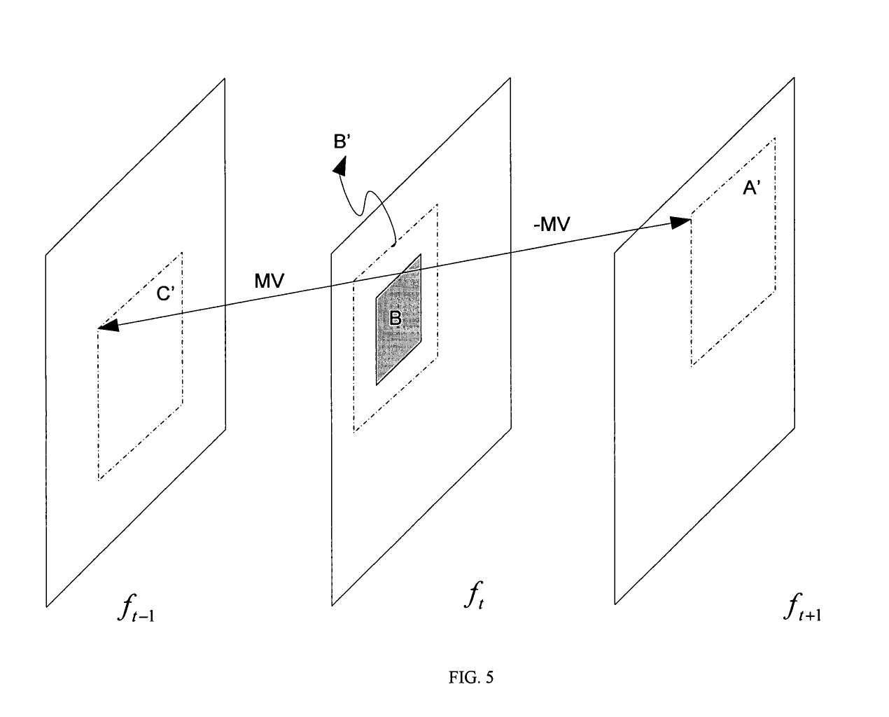

The symmetric motion estimation used in the system 100 is based on the assumption that motion is constant in a short time period. FIG. 5 shows a diagrammatical example of symmetric motion estimation for an interlaced video sequence, according to an embodiment of the present invention. As shown in FIG. 5, if MV is the motion vector of block B′ to the previous image fₜ₋₁, then −MV is the motion vector of block B′ to the next image fₜ₊₁. Such that, for each matching block candidate C′ in the previous image fₜ₋₁ with motion vector candidate MV, the corresponding matching block candidate A′ in the next image fₜ₊₁ with motion vector candidate −MV can be obtained since it is assumed that the motion is symmetric.

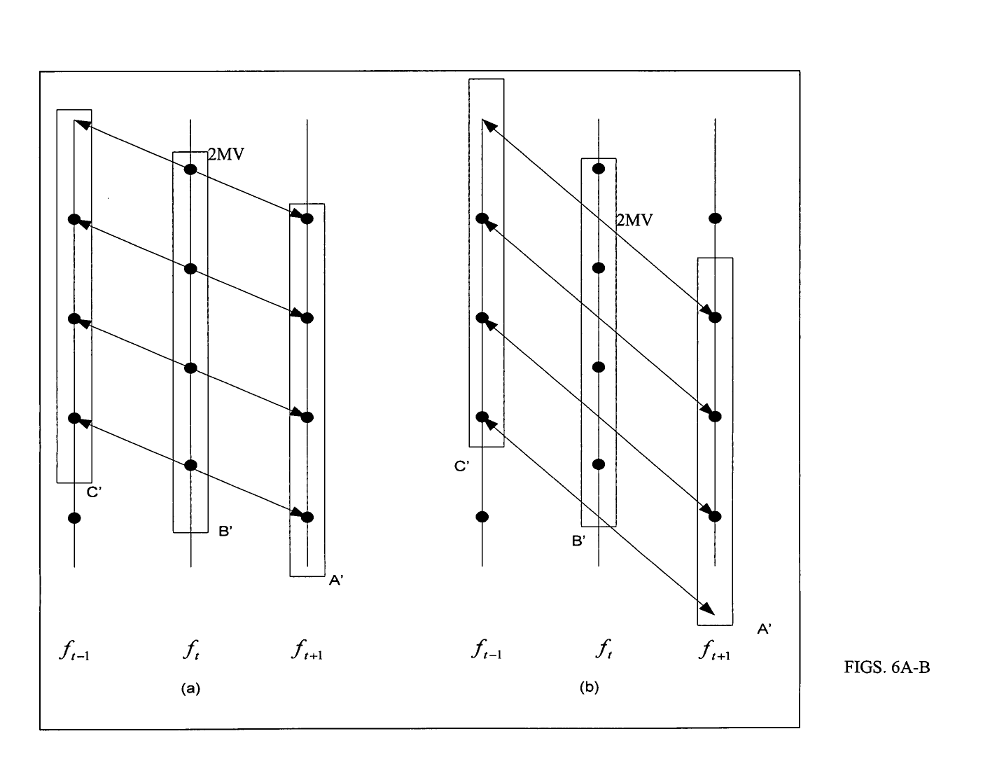

The difference between the blocks C′ and A′ such as mean absolution error or mean square error, can be calculated to determine whether blocks C′ and A′ are matched. FIGS. 6A-B shows examples of symmetric block matching in an interlaced video sequence, according to an embodiment of the present invention. Specifically, FIGS. 6A-B diagrammatically shows two example of the aforementioned difference calculation, wherein the arrows 601, 602 are motion vector pointers.

In the example in FIG. 6A, blocks C′, B′, A′ of images fₜ₋₁, fₜ, fₜ₊₁, respectively, are shown (solid circle indicates pixels). In this example, the vertical direction component of 2MV (i.e., motion vector from the previous image fₜ₋₁ to the next image fₜ₊₁), is an odd number.

In another example in FIG. 6B, blocks C′, B′, A′ of images fₜ₋₁, fₜ, fₜ₊₁, respectively, are shown. In this example, the vertical direction component of 2MV (i.e., motion vector from the previous image fₜ₋₁ to the next image fₜ₊₁), is an even number.

As such, the matching difference can be calculated between blocks C′ and A′ without using any pixel information in the current image fₜ. By trying all the motion vector candidates using full search or other methods, the best matching blocks of B′ in the previous and next images, respectively, can be found. Accordingly, the motion vector MV1 and MV2 can be obtained that satisfy MV1=−MV2 from the motion vector from previous to next field to obtain the motion vector from current to previous, next field respectively.

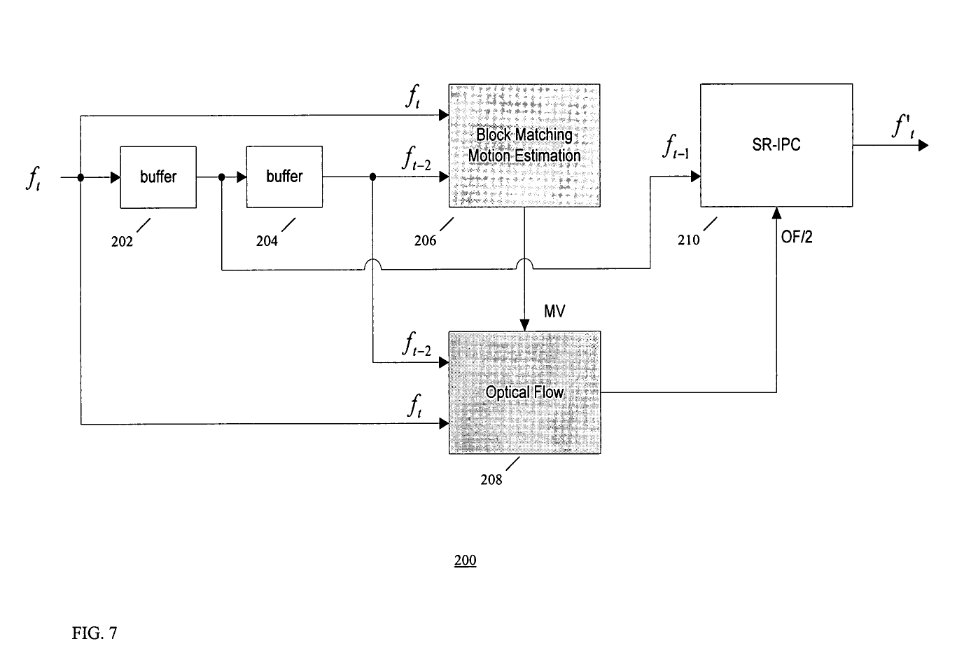

FIG. 7 shows an example block diagram of another super resolution based deinterlacing system 200, according to an embodiment of the present invention. The system 200 includes buffers 202, 204 (maintaining the previous and previous-previous frames, respectively), a block matching motion estimation (BMME) unit 206, an optical flow unit 208 and a SR-IPC unit 210.

In system 200, assume input image fₜ is the current image, block B is the current block to be processed and block B′ is the external block of block B. The BMME 206 searches the motion vector of block B′ between the current image fₜ and the second previous image fₜ₋₂ using a block matching method to generate a motion vector as MV.

Using MV as the initial motion vector, the optical flow unit 208 is applied on the block B′ between the current image fₜ and the second previous image fₜ₋₂, the to generate a sub-pixel resolution motion vector OF. Based upon the assumption that motion is constant in a short time period, the optical flow unit 208 calculates the sub-pixel resolution motion vector of block B′ from the current image fₜ to the previous image fₜ₋₁, as OF/2.

Accordingly, the missing pixels in block B can be compensated from the interpolated pixels in the previous image fₜ₋₁ based on the motion vector OF/2 as it is assumed that the motion is symmetric.

SR-IPC 210 interpolates the missing pixel based on the obtained sub-pixel resolution motion vector, whereby f′t is a deinterlaced frame.

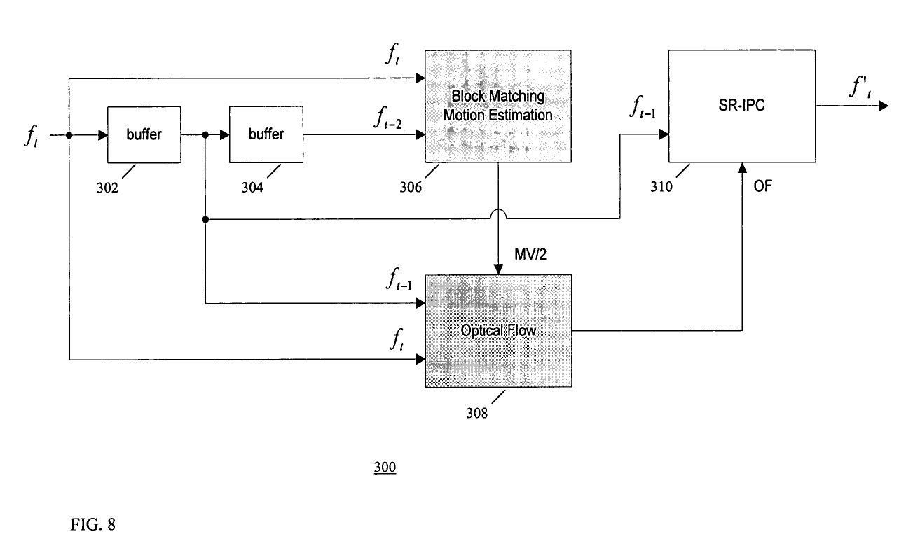

FIG. 8 shows an example block diagram of a super resolution based deinterlacing system 300, according to an embodiment of the present invention. The system 300, includes buffers 302, 304 (maintaining the previous and previous-previous frames, respectively), a block matching motion estimation (BMME) unit 306, an optical flow unit 308 and a SR-IPC unit 310 that interpolates the missing pixel based on the sub-pixel resolution motion vector.

In system 300, assume input image fₜ is the current image, block B is the current block to be processed and block B′ is the external block of block B. The BMME unit 306 first searches the motion vector of block B′ between the current image fₜ and the second previous image fₜ₋₂ using a block matching method, to generate a motion vector MV. Based upon the assumption that motion is constant in a short time period, the BMME unit 306 calculates the motion vector of block B′ from the current image fₜ to the previous image fₜ₋₁, as MV/2.

Using MV/2 as the initial motion vector, the optical flow unit 308 is applied on the block B′ between the current image fₜ and the previous image fₜ₋₁ to generate a sub-pixel resolution motion vector OF.

Accordingly, the missing pixels in block B can be compensated from the interpolated pixels in the previous image fₜ₋₁ based on the motion vector OF using motion compensated interpolation. SR-IPC 310 interpolates the missing pixel based on the sub-pixel resolution motion vector, whereby f′ₜ is a deinterlaced frame.

While the present invention is susceptible of embodiments in many different forms, these are shown in the drawings and herein described in detail, preferred embodiments of the invention with the understanding that this description is to be considered as an exemplification of the principles of the invention and is not intended to limit the broad aspects of the invention to the embodiments illustrated. The aforementioned example architectures above according to the present invention can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of processing interlaced video including a sequence of interlaced image fields, comprising the steps of:
(a) estimating a motion vector for a block of pixels in a current image field including multiple blocks;
(b) reconstructing a pixel value in the block based on the motion vector.

2. The method of claim 1 wherein the step of reconstructing further includes the steps of interpolating the pixel value.

3. The method of claim 2 wherein the step of reconstructing further includes the steps of interpolating a missing pixel value.

4. The method of claim 1 wherein the step of estimating a motion vector further includes the steps of performing block matching on the block to obtain a motion vector MV.

5. The method of claim 4 wherein:
the step of estimating a motion vector further includes the steps of using MV as the initial motion vector, applying optical flow to the block to obtain a sub-pixel resolution motion vector OF;
the step of reconstructing further includes the steps of reconstructing the pixel value in the block based on the motion vector OF.

6. The method of claim 5 wherein the step of reconstructing further includes the steps of reconstructing the pixel value in the block based on the motion vector OF and one or more fields in the sequence.

7. The method of claim 6 wherein the step of reconstructing further includes the steps of interpolating the pixel value in the block based on the motion vector OF and one or more fields in the sequence.

8. The method of claim 1 further comprising the steps of performing steps (a) and (b) for each block in the current image field.

9. The method of claim 8 wherein the step of estimating a motion vector further includes the steps of performing motion estimation on overlapping blocks.

10. The method of claim 9 wherein the step of estimating a motion vector for a block B further comprises the steps of performing motion estimation on a larger external block B′ relative to block B.

11. A method of processing interlaced video including a sequence of interlaced image field, comprising the steps of:
for each block of pixels in a current image field including multiple blocks, performing super resolution-based deinterlacing by:
estimating a motion vector MV representing displacement;
using MV as the initial motion vector, applying optical flow to that block to obtain a sub-pixel resolution motion vector OF; and
reconstructing the pixel value in that block based on the motion vector OF.

12. The method of claim 11 wherein the step of estimating a motion vector further includes the steps of performing block matching on the block to obtain a motion vector MV.

13. The method of claim 12 wherein the step of estimating a motion vector for a block B in a current image fₜ at time t, includes the steps of:
applying block matching-based motion estimation on an external block B′ overlapping block B, between the current image fₜ and one a neighboring images fₛ, to obtain a motion vector MV.

14. The method of claim 13 wherein the step of applying optical flow further includes the steps of:
using the motion vector MV as the initial motion vector, applying optical flow to the external block B′ to obtain a sub-pixel resolution motion vector OF.

15. The method of claim 14, wherein the step of reconstructing a pixel value in block B further includes the steps of:
based on the sub-pixel resolution motion vector OF, interpolating a matched block C in frame fₛ.

16. The method of claim 15 wherein the step of reconstructing further includes the steps of:
interpolating missing pixels in block B from block C with motion compensation.

17. A system for processing interlaced video including a sequence of interlaced image frames, comprising:
(a) a motion estimator that estimates a motion vector for a block of pixels in a current image frame including multiple blocks;
(b) a pixel re-constructor that reconstructs a pixel value in the block based on the motion vector.

18. The system of claim 17 wherein the re-constructor comprises an interpolator for interpolating the pixel value.

19. The system of claim 18 wherein interpolator interpolates a missing pixel value.

20. The system of claim 17 wherein the motion estimator performs block matching on the block to obtain a motion vector MV representing displacement.

21. The system of claim 20 wherein:
the motion estimator uses MV as the initial motion vector, the system further including an optical flow function that is applied to the block to obtain a sub-pixel resolution motion vector OF;
the re-constructor reconstructs the pixel value in the block based on the motion vector OF.

22. The system of claim 21 wherein the re-constructor reconstructs pixel value in the block based on the motion vector OF and one or more frames in the sequence.

23. The system of claim 21 wherein the re-constructor includes an interpolator that interpolates the pixel value in the block based on the motion vector OF and one or more frames in the sequence.

24. The system of claim 17 wherein each block in the current image frame is processed through the motion estimator and the re-constructor.

25. The system of claim 23 wherein the motion estimator performs motion estimation on overlapping blocks.

26. The system of claim 25 wherein the motion estimator estimates a motion vector for a block B by performing motion estimation on a larger external block B1 relative to block B.

27. A de-interlacing system processing interlaced video including a sequence of interlaced image frames, comprising:
a de-interlacer that for each block of pixels in a current image frame including multiple blocks, performs super resolution-based deintelacing;
the de-interlacer comprising:
a motion estimator that estimates a motion vector MV representing displacement;
an optical flow function that uses MV as the initial motion vector, and applies optical flow to that block to obtain a sub-pixel resolution motion vector OF; and
a re-constructor that reconstructs the pixel value in that block based on the motion vector OF.

28. The system of claim 27 wherein the motion estimator performs block matching on the block to obtain a motion vector MV.

29. The system of claim 28 wherein the motion estimator estimates a motion vector for a block B in a current image fₜ at time t, by:
applying block matching-based motion estimation on an external block B′ overlapping block B, between the current image fₜ and one a neighboring images fₛ, to obtain a motion vector MV.

30. The system of claim 29 wherein optical flow function applies optical flow by using the motion vector MV as the initial motion vector, and applying optical flow to the external block B′ to obtain a sub-pixel resolution motion vector OF.

31. The system of claim 30 wherein the re-constructor reconstructs a pixel value in block B based on the sub-pixel resolution motion vector OF, and interpolating a matched block C in frame fₛ.

32. The system of claim 31 wherein the re-constructor includes an interpolator for interpolating missing pixels in block B from block C with motion compensation.
